(19) United States
(12) Patent Application Publication
(10) Pub. No.: US 2020/0379319 A1
(43) Pub. Date: Dec. 3, 2020

(54) LENS APPARATUS AND IMAGE PICKUP APPARATUS

(71) Applicant: CANON KABUSHIKI KAISHA, Tokyo (JP)

(72) Inventor: Katsuhisa Aoki, Utsunomiya-shi (JP)

(21) Appl. No.: 16/880,268

(22) Filed: May 21, 2020

(30) Foreign Application Priority Data
May 31, 2019 (JP) 2019-102305

(51) Int. Cl. G03B 17/14; G02B 7/02

(52) U.S. Cl. CPC G03B 17/14; G02B 7/022

(57) ABSTRACT

A lens apparatus includes: an optical element; a lens barrel configured to hold the optical element; and an adjusting member configured to be inserted into a space formed in the lens barrel and deform the lens barrel to adjust a shape of the optical element.

### BACKGROUND OF THE INVENTION

### Field of the Invention

The present invention relates to a lens apparatus and an image pickup apparatus.

### Description of the Related Art

In recent years, a lens system to be installed in a broadcasting lens apparatus (TV lens apparatus) is desired to have higher imaging performance than that in the related art to conform to, for example, 4K or 8K television broadcast standards. Thus, it is required to reduce aberrations of individual lenses included in the lens system. However, the lenses may be deformed while being processed or held, and, as a result, an astigmatism may occur. Thus, there is a limit to improve the imaging performance of the lens system only by reducing the aberrations of the individual lenses.

In order to improve the imaging performance of the lens system, there is known a technology involving actively deforming one lens included in the lens system to cause an aberration that can cancel aberrations caused by other lenses included in the lens system, to thereby achieve high imaging performance as the lens system. In Japanese Patent Application Laid-Open No. 2006-156713, there is disclosed a technology involving changing a height of a support point of the lens to cause deformation of the lens by its own weight.

However, an optical element holding device disclosed in Japanese Patent Application Laid-Open No. 2006-156713 is upsized due to a complicated mechanism. Along with the upsizing, the holding device may have a disadvantage also in terms of ease of assembly. Further, the holding device is configured to hold a lens being placed flat through use of the lens's own weight, and is mainly suitable for an apparatus to be used under an environment in which an external force is relatively rarely applied, such as a semiconductor exposure apparatus. Consequently, the holding device is not suitable for use in a broadcasting lens apparatus or other apparatus that is frequently applied with an external force.

### SUMMARY OF THE INVENTION

An aspect of embodiments of the present invention provides, for example, a lens apparatus beneficial in aberration correction.

According to an aspect of embodiments, a lens apparatus includes an optical element; a lens barrel configured to hold the optical element; and an adjusting member configured to be inserted into a space formed in the lens barrel and deform the lens barrel to adjust a shape of the optical element by deforming the lens barrel.

Further features of the present invention will become apparent from the following description of exemplary embodiments with reference to the attached drawings.

### BRIEF DESCRIPTION OF THE DRAWINGS

FIG. 1 is a perspective view of an optical element holding device in a first embodiment of the present invention.

FIG. 2 is a sectional view of the optical element holding device in the first embodiment.

FIG. 3 is a detailed view of a portion A of FIG. 2.

FIG. 4 is a view of a state of adjustment in the first embodiment.

FIG. 5 is a view of the state of adjustment in the first embodiment.

FIG. 6 is a sectional view of an optical element holding device in a second embodiment of the present invention.

FIG. 7 is a detailed view of a portion B of FIG. 6.

FIG. 8 is a sectional view taken along the line C-C of FIG. 7.

FIG. 9 is an exploded perspective view of a main portion of a lens apparatus of the second embodiment.

FIG. 10 is a view of a state of adjustment in the second embodiment.

### DESCRIPTION OF THE EMBODIMENTS

Now, exemplary embodiments of the present invention are described in detail based on the attached drawings.

### First Embodiment

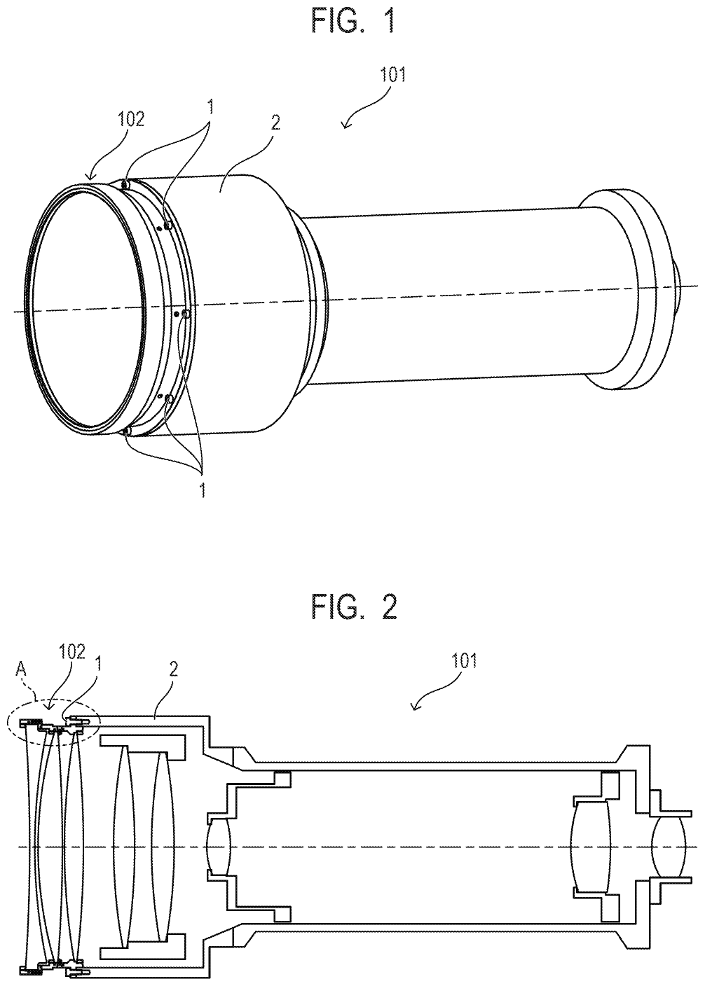

Now, with reference to FIG. 1 to FIG. 5, description is made of a lens apparatus including an optical element holding device according to a first embodiment of the present invention.

With reference to FIG. 1 and FIG. 2, description is made of a lens apparatus 101 including an optical element holding device according to the first embodiment of the present invention. The lens apparatus 101 includes a plurality of optical element holding devices including an optical element holding device 102. The optical element holding device 102 is held by a housing 2 through use of a plurality of bolts 1 (fastening member).

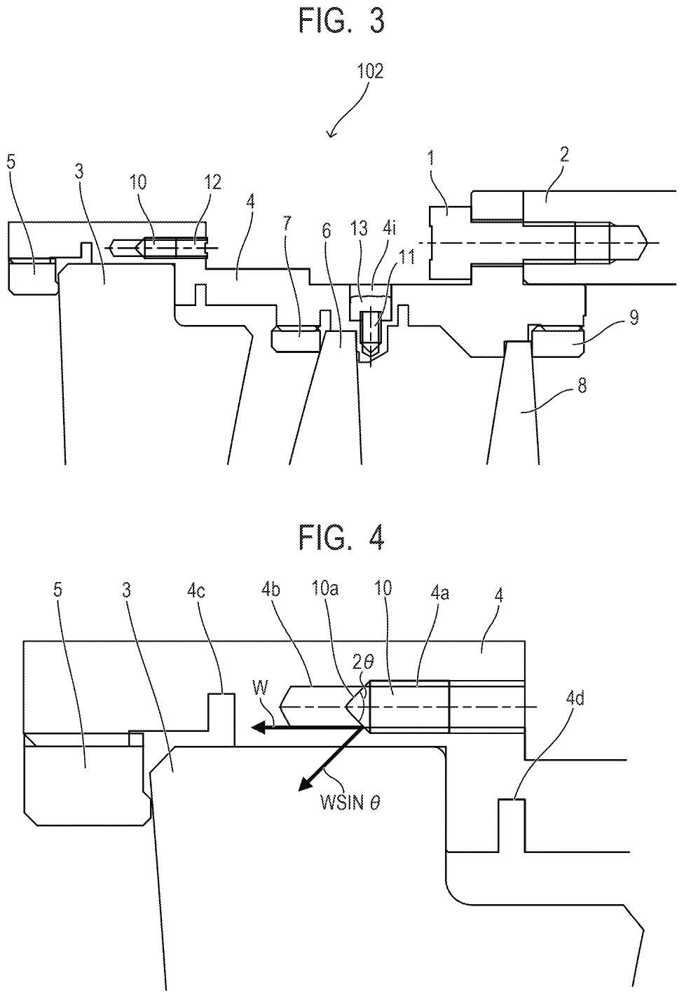

With reference to FIG. 3, details of the optical element holding device 102 are described. FIG. 3 is a detailed view of a portion A of FIG. 2. A lens 3 is pressed and fixed to an abutment surface (abutting portion) of an inner diameter portion of a lens barrel 4 when a male screw of an outer peripheral surface of a pressing ring 5 (fixing member) is threadedly engaged with a female screw of an inner peripheral surface of the lens barrel 4. A lens 6 is pressed and fixed to an abutment surface of the lens barrel 4 when a male screw of an outer peripheral surface of a pressing ring 7 (fixing member) is threadedly engaged with a female screw of the inner peripheral surface of the lens barrel 4. A lens 8 is pressed and fixed to an abutment surface of the lens barrel 4 when a male screw of an outer peripheral surface of a pressing ring 9 is threadedly engaged with a female screw of the inner peripheral surface of the lens barrel 4. Further, in the lens barrel 4, a plurality of (ex. at least eight) wedge screws 10 and wedge screws 11 are arranged to have the same phase (ex. at least eight same portions) as the bolts 1 about an axis of the lens barrel 4.

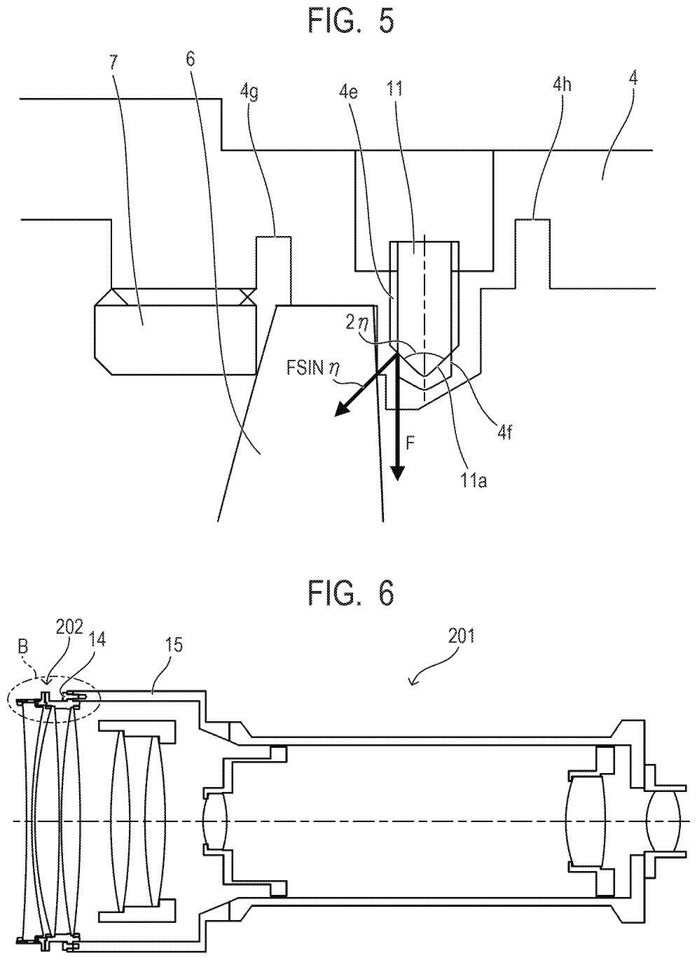

With reference to FIG. 4 and FIG. 5, description is made of a method of adjusting the lens apparatus 101 by the optical element holding device 102. In an outer diameter portion of the lens barrel 4, a screw portion 4a (female screw portion) and a hole portion 4b are formed. The screw portion 4a (female screw portion) is formed to be threadedly engaged with a male screw portion of the wedge screw (adjusting member) 10. The hole portion 4b has a diameter that is smaller than a root diameter of the wedge screw 10. With the above-mentioned structure, when the wedge screw 10 is threadedly engaged and tightened to the screw portion 4a, the hole portion 4b and a tapered portion 10a of the wedge screw 10 cause an axial tension by the screw. When a part of the generated axial tension is represented by W, and a taper angle of the tapered portion 10a is represented by 2θ, the lens barrel 4 is applied with a force of WSINθ, and thus the hole portion 4b is deformed to be widened. As a result, the outer peripheral surface of the lens 3 is brought into contact with the inner peripheral surface (contact portion) of the lens barrel 4, and hence the deformation of the lens barrel 4 causes a force to be applied to the lens 3 supported by the lens barrel 4, and thus the lens 3 is deformed. That is, the adjusting member is shaped so as to change the shape of the optical element in accordance with the change in arrangement with respect to the hole portion 4b into which the adjusting member is inserted.

Further, the lens barrel 4 has, on both sides across the hole portion 4b in an optical axis direction, notch portions 4c and 4d each having a longitudinal direction in a circumferential direction about an optical axis as a center thereof. With this configuration, the deformation caused by the force applied to the lens barrel 4 is absorbed by the notch portions 4c and 4d. Consequently, the pressing ring 5, the pressing ring 7, and the lens 6, which are located on opposite sides of the notch portions 4c and 4d with respect to the hole portion 4b in the optical axis direction, can be less affected, and only the lens 3 can be deformed. In the first embodiment, the lens barrel 4 has the notch portions 4c and 4d on both sides across the hole portion 4b in the optical axis direction, but the present invention is not limited to this configuration. As long as the lens barrel 4 has a notch portion on at least one of both sides across the hole portion 4b in the optical axis direction, the effect of the present invention can be achieved.

Similarly, in the lens barrel 4, a screw portion 4e and a hole portion 4f are formed. The screw portion 4e is formed to be threadedly engaged with a male screw portion of the wedge screw 11 (adjusting member). The hole portion 4f is formed in the outer diameter portion of the lens barrel 4 in a direction perpendicular to the optical axis, and has a diameter equal to or smaller than a root diameter of the wedge screw 11. With the above-mentioned structure, when the wedge screw 11 is threadedly engaged and tightened to the screw portion 4e, the hole portion 4f and a tapered portion 11a of the wedge screw 11 cause an axial tension by the screw. When a part of the generated axial tension is represented by F, and a taper angle of the tapered portion 11a is represented by 2η, the lens barrel 4 is applied by a force of FSINη, and the hole portion 4f is deformed to be widened. As a result, the deformation of the lens barrel 4 causes a force to be applied to the lens 6 supported by the lens barrel 4, and thus the lens 6 is deformed.

Further, the lens barrel 4 has notch portions 4g and 4h formed on both sides across the hole portion 4f in the optical axis direction. With this configuration, the deformation caused by the force applied to the lens barrel 4 is absorbed by the notch portions 4g and 4h. Consequently, the pressing ring 7 and the lens 8, which are located on opposite sides of the notch portions 4g and 4h with respect to the hole portion 4f in the optical axis direction, can be less affected, and only the lens 6 can be deformed.

With those operations, there can be caused, in the lens 3 and the lens 6, aberrations for canceling astigmatisms that the whole lens apparatus 101 has, including an aberration caused when the lens is fixed to the lens barrel 4 by each pressing ring, an aberration caused when the lens barrel 4 is fastened to the housing 2 by the bolts 1, and other aberrations that the optical element holding device has.

That is, the imaging performance of the lens apparatus 101 can be corrected by tightening the wedge screw 10 and the wedge screw 11. In this case, portions to tighten the wedge screws 10 and the wedge screws 11 are selected as appropriate from a plurality of portions (at least eight portions, for example) about the optical axis, and tightening amounts of the wedge screw 10 and the wedge screw 11 are adjusted. In this manner, an optimum astigmatism can be caused. After the imaging performance is corrected, as illustrated in FIG. 3, under a state in which the wedge screw 10 is biting into the hole portion, the wedge screw 10 is fixed by a set screw 12 (fixing mechanism). Further, under a state in which the wedge screw 11 is biting into a hole portion 4i formed in the lens barrel 4, the wedge screw 11 is fixed by filling the hole portion 4i with an adhesive 13 (fixing mechanism).

As described above, according to the first embodiment, the imaging performance can be corrected by the wedge screw 10 and the wedge screw 11 while the imaging performance of the lens apparatus 101 is checked. Thus, the lens apparatus 101 can be effectively adjusted without being disassembled. Further, the lens is deformed by deforming a lens engaging portion of the lens barrel 4, and hence a member for fixing the lens, for example, the pressing ring, is not affected. Thus, a lens holding force is not degraded. In addition, the wedge screw 10 and the wedge screw 11 are firmly fixed through use of the set screw 12 and the adhesive 13, and thus the imaging performance is not degraded even when the lens apparatus 101 is used under an environment in which an external force is applied. Further, the lens apparatus 101 is formed of a small number of components and simple components, and hence the cost can be reduced.

### Second Embodiment

Now, with reference to FIG. 6 to FIG. 10, description is made of an optical element holding device according to a second embodiment of the present invention.

With reference to FIG. 6, description is made of a lens apparatus 201 including an optical element holding device according to the second embodiment of the present invention. The lens apparatus 201 includes a plurality of optical element holding devices including an optical element holding device 202. The optical element holding device 202 is held by a housing 15 through use of bolts 14 (fastening member).

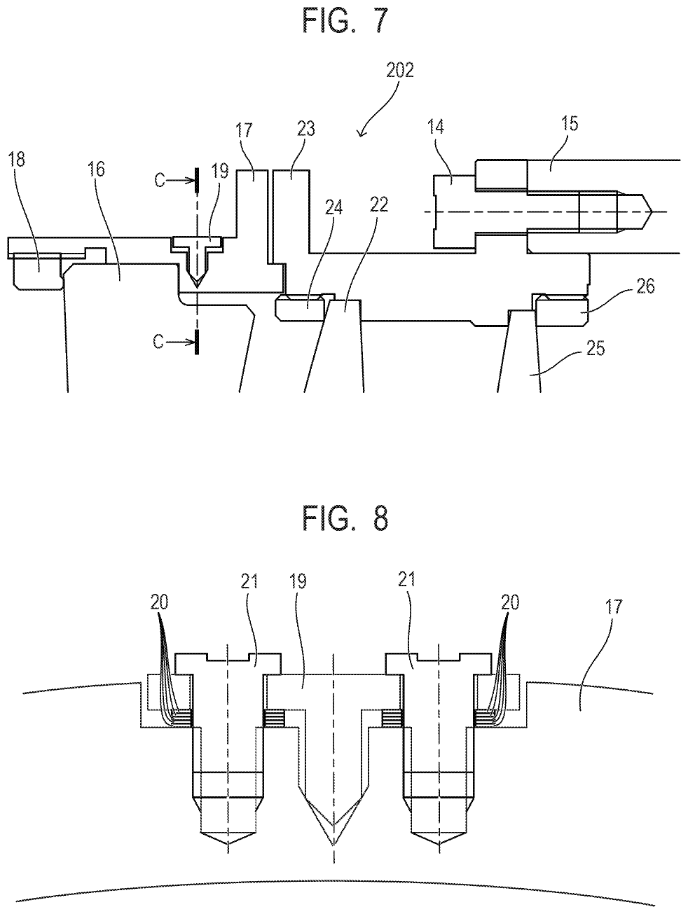

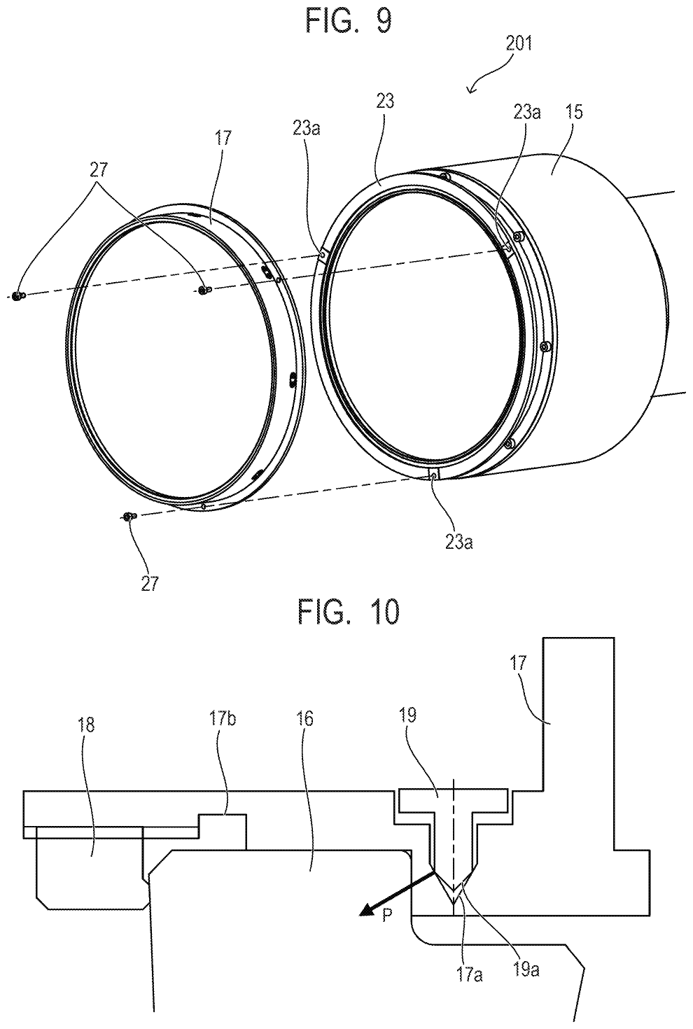

With reference to FIG. 7 to FIG. 9, details of the optical element holding device 202 are described. FIG. 7 is a detailed view of a portion B of FIG. 6. FIG. 8 is a sectional view taken along the line C-C of FIG. 7. FIG. 9 is an exploded perspective view of a main portion of the lens apparatus 201.

A lens 16 is pressed and fixed to an abutment surface of a lens barrel 17 (first lens barrel) when a male screw of an outer peripheral surface of a pressing ring 18 is threadedly engaged with a female screw of an inner peripheral surface of the lens barrel 17. Further, in the lens barrel 17, a plurality of wedge members 19 are arranged. Each of the wedge members 19 is fixed (fastened) to the lens barrel 17 by screws 21 (fixing mechanism, screw member) through intermediation of a plurality of washers 20 (adjusting mechanism). A lens 22 is pressed and fixed to an abutment surface of a lens barrel 23 (second lens barrel) when a male screw of an outer peripheral surface of a pressing ring 24 is threadedly engaged with a female screw of an inner peripheral surface of the lens barrel 23. A lens 25 is pressed and fixed to an abutment surface of the lens barrel 23 when a male screw of an outer peripheral surface of a pressing ring 26 is threadedly engaged with a female screw of the inner peripheral surface of the lens barrel 23. Further, the lens barrel 17 is fixed to three protruding portions 23a (abutment portion) of the lens barrel 23 by bolts 27. In this case, the wedge members 19 and the protruding portions 23a are arranged at different phases.

With reference to FIG. 10, description is made of a method of adjusting the lens apparatus 201 by the optical element holding device 202. When the wedge member 19 is fixed to the lens barrel 17 by the screws 21 through intermediation of the washers 20, a leading end 19a of the wedge member 19 abuts against a tapered portion 17a of the lens barrel 17, and further the wedge member 19 bites into the tapered portion 17a of the lens barrel 17. Thus, the lens barrel 17 is applied with a force of P to be deformed. As a result, in response to the deformation of the lens barrel 17, the lens 16 is also deformed. Further, the lens barrel 17 has a notch portion 17b. Consequently, the deformation caused by a force applied to the lens barrel 17 is absorbed by the notch portion 17b, and the pressing ring 18 can be less affected.

Further, the lens barrel 17 and the lens barrel 23 are connected to each other at the three protruding portions 23a having phases different from those of the wedge members 19. As illustrated in FIG. 7, the lens barrel 17 and the lens barrel 23 are not restricted in the optical axis direction at a position at the same phase as that of the wedge member 19. With this configuration, the deformation of the lens barrel 17 is not transmitted to the lens barrel 23, and hence only the lens 16 can be deformed. With those operations, there can be caused in the lens 16 an aberration for canceling astigmatisms that the whole lens apparatus 201 has, including an aberration caused when the lens is fixed by each pressing ring, an aberration caused by the bolts 14, and other aberrations that the optical element holding device has.

That is, the imaging performance of the lens apparatus 201 can be corrected by fixing the wedge members 19 to the lens barrel 17. In this case, portions to fix the wedge members 19 are selected as appropriate, and the number of washers 20 is adjusted so that an optimum astigmatism can be caused.

As described above, according to the second embodiment, the imaging performance can be corrected by the wedge member 19 while the imaging performance of the lens apparatus 201 is checked. Consequently, the lens apparatus 201 can be effectively adjusted without being disassembled. Further, the lens 16 is deformed by deforming a lens engaging portion of the lens barrel 17, and hence a member for fixing the lens, for example, the pressing ring, is not affected. As a result, a lens holding force is not degraded. In addition, the wedge member 19 is firmly fixed by the screws 21, and thus the imaging performance is not degraded even when the lens apparatus 201 is used under an environment in which an external force is applied. Further, the lens apparatus 201 is formed of a small number of components and simple components, and hence the cost can be reduced.

Further, through the arrangement of the image pickup apparatus including the lens apparatus of the present invention and the image pickup element provided at an image plane of the lens apparatus, the image pickup apparatus having an effect of the present invention can be achieved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-102305, filed May 31, 2019, which is hereby incorporated by reference herein in its entirety.

What is claimed is:

1. A lens apparatus comprising:
an optical element;
a lens barrel configured to hold the optical element; and
an adjusting member configured to be inserted into a space formed in the lens barrel and deform the lens barrel to adjust a shape of the optical element.

2. The lens apparatus according to claim 1, wherein the adjusting member is configured to be inserted into the space which has a dimension smaller than that of the adjusting member in a direction.

3. The lens apparatus according to claim 2, wherein the adjusting member is configured to be inserted into a hole, as the space, formed in the lens barrel, and has a shape to deform the lens barrel in accordance with change in a placement of the adjusting member relative to the hole.

4. The lens apparatus according to claim 1, wherein the adjusting member is configured to be inserted into the space at each of portions, of the lens barrel, whose number is at least eight.

5. The lens apparatus according to claim 3,
wherein the lens barrel includes an abutting portion against which the optical element abuts in a direction of an optical axis of the optical element, and
wherein the lens apparatus further comprises a fixing member configured to fix the optical element to the lens barrel by pressing the optical element toward the abutting portion.

6. The lens apparatus according to claim 5, wherein the hole is formed in the abutting portion.

7. The lens apparatus according to claim 3,
wherein the lens barrel includes a contact portion to be in contact with an outer diameter portion of the optical element, and
wherein the hole is formed along the contact portion.

8. The lens apparatus according to claim 3, further comprising:
an adjusting mechanism configured to adjust the placement of the adjusting member; and
a fixing mechanism configured to fix the adjusting member.

9. The lens apparatus according to claim 8,
wherein the adjusting member includes a male screw portion, and
wherein the adjusting mechanism includes a female screw portion, formed in the lens barrel, screwed with the male screw portion.

10. The lens apparatus according to claim 8, wherein the fixing mechanism includes at least one of an adhesive and a screw member.

11. The lens apparatus according to claim 10, wherein the adjusting mechanism includes a washer disposed in fastening of the adjusting member by the screw member.

12. The lens apparatus according to claim 5, wherein a notch is formed in the lens barrel on at least one of both sides thereof of the hole in the direction of the optical axis, the notch having a longitudinal direction in a circumferential direction of the lens barrel.

13. The lens apparatus according to claim 12, wherein the notch is formed between the hole and the fixing member in the direction of the optical axis.

14. The lens apparatus according to claim 12, wherein the notch is formed on an opposite side of the hole with respect to the optical element in the direction of the optical axis.

15. The lens apparatus according to claim 1,
wherein the lens barrel includes a first lens barrel and a second lens barrel fastened to each other at a plurality of portions in a circumferential direction of the lens barrel, and
wherein each of the plurality of portions and the adjusting member are placed at positions different from each other in the circumferential direction of the lens barrel.

16. The lens apparatus according to claim 1, further comprising:
a housing; and
a fastening member configured to fasten the lens barrel to the housing,
wherein the fastening member and the adjusting member are placed at the same position in a circumferential direction of the lens barrel.

17. An image pickup apparatus comprising:
a lens apparatus comprising:
an optical element;
a lens barrel configured to hold the optical element; and
an adjusting member configured to be inserted into a space formed in the lens barrel and deform the lens barrel to adjust a shape of the optical element; and
an image pickup element configured to receive an image formed by the lens apparatus.
